(19) United States
(12) Patent Application Publication
(10) Pub. No.: US 2015/0336081 A1
(43) Pub. Date: Nov. 26, 2015

(54) MAGNETIC ADSORBENTS, METHODS FOR MANUFACTURING A MAGNETIC ADSORBENT, AND METHODS OF REMOVAL OF CONTAMINANTS FROM FLUID STREAMS

(71) Applicant: Clear Carbon Innovations LLC, Gainesville, FL (US)

(72) Inventors: David W. Mazyck, Gainesville, FL (US); Heather Byrne, Gainesville, FL (US); Ameena Khan, Gainesville, FL (US)

(73) Assignee: Clear Carbon Innovations LLC, Gainesville, FL (US)

(21) Appl. No.: 14/349,636

(22) PCT Filed: Feb. 20, 2013
(86) PCT No.: PCT/US2013/026863

§ 371 Date: Apr. 3, 2014

Related U.S. Application Data
(60) Provisional application No. 61/660,475, filed on Jun. 15, 2012.

(51) Int. Cl. B01J 20/28; B01J 20/20; B01D 53/12; C04B 18/08; B01D 53/86; B01J 20/06; B01J 20/30

(52) U.S. Cl. CPC B01J 20/28009; B01J 20/06; B01J 20/20; B01J 20/3021; C04B 18/08; B01D 53/8665; B01D 53/12; B01D 2255/802; B01D 2257/602; B01D 2253/102

(57) ABSTRACT

A magnetic adsorbent includes an adsorbent and iron oxide implanted onto a surface of the adsorbent, wherein a total surface area of the magnetic adsorbent is not substantially less than a total surface area of the adsorbent. Optionally, the adsorbent is activated carbon.

### CROSS-REFERENCE TO RELATED APPLICATIONS

This application claims the benefit of International Patent Application No. PCT/US13/26863 filed Feb. 20, 2013, which claims the benefit of U.S. Provisional Application No. 61/634,848 filed Mar. 7, 2012, which is hereby incorporated by reference to the same extent as though fully contained herein.

### BACKGROUND

Amongst the numerous hazardous air pollutants (HAPs) currently regulated by the EPA, mercury and mercury-containing compounds have been a source of significant concern due to their increasing rate of release and the lack of adequate control technologies. Although the resulting quantity in the environment is usually low, it can transfer to various organisms, and then magnify up the food chain. For example, the concentration of accumulated mercury in some fish can reach levels that are millions of times greater than that in the water. The consumption of such fish by humans, and the resulting buildup of mercury in various tissues may lead to serious neurological and developmental effects such as losses of sensory or cognitive ability, tremors, inability to walk, convulsions, and even death. Methylmercury, the most common form of organic mercury, is almost completely incorporated into the blood stream, and can be transferred through the placenta and into all of the tissues of the fetus, including that of the brain. Because of the health concerns related to eating mercury contaminated fish, bans on fishing in certain regions such as in the Great Lakes have resulted in considerable losses to the economy.

The EPA has estimated that nearly 87% of the anthropogenic mercury emissions are from sources such as waste (as in waste-to-energy facilities) and fossil fuel combustion (as in coal-fired power plants). Recognizing this, control technologies have been employed in an effort to capture and dispose of the mercury found in combustion exhaust gases. Currently, Powdered Activated Carbon (PAC) injection into the flue gas stream is the best demonstrated control technology for mercury removal. The demand for Powdered Activated Carbon for Mercury capture is expected to grow to approximately 260,000 tons per year based on Freedonia estimates when the regulations for mercury removal, based on the 4813-6179-6634.1. Mercury and Air Toxics Standards, are implemented in the year 2015. The increased implementation will exact a significant economic burden on regulated facilities. Currently, brominated activated carbons have been shown to have the highest mercury removal rate per pound of product. However, these products have a higher cost margin—and therefore would increase the economic impact—and may cause corrosion of plant equipment. Furthermore, PAC's generally low mercury adsorption efficiency and lack of adequate regeneration technologies have sparked an interest in modifying the material to either decrease costs or improve performance.

Another shortcoming in using PAC injection systems is the accumulation of the waste PAC in the fly ash. Fly ash, the fine particulate fraction of the Coal Combustion Byproducts (CCBs) (i.e., noncombustible inorganics and uncombusted carbon), is collected from flue gas and then commonly sold for beneficial reuse in the production of concrete and other materials. Replacing lime, cement, or crushed stone materials that are typically used in construction materials with fly ash can conserve energy and resources, while providing an alternative to landfill disposal of the waste. However, when typical fly ash collection devices are coupled with PAC injection systems, the quality of the collected fly ash deteriorates because of the large fraction of carbon in the ash. Such fly ash cannot be resold for beneficial reuse and must, instead, be landfilled. Current research geared towards separation technologies has yet to find an adequate method to isolate the PAC from the fly ash. Therefore, a method that can easily separate PAC from the fly ash is desirable. Such a method will (a) maintain the quality of the fly ash for subsequent sale and reuse, and (b) permit the reuse of the PAC for additional mercury capture.

U.S. Pat. No. 7,879,136 teaches a method to recover PAC from fly ash by creating a magnetic activated carbon through a wet precipitation method. This method is similar to U.S. Pat. Nos. 2,479,930, 6,914,034, and 8,097,185B2, which also teach wet methods using iron precursors to make a magnetic activated carbon. Others have created magnetic adsorbents by: combining the sorbent with a magnetic material using a binder (U.S. Pat. No. 7,429,330), mixing a sorbent with a magnetic material (U.S. Pat. No. 4,260,523), or mixing a magnetic material with an organic material, followed by activation (U.S. Pat. Nos. 4,260,523, 4,201,831, and 7,429,330).

While the methods described by the referenced patents serve well for bench-scale applications, they introduce challenges for full-scale production including, but not limited to, high energy costs. Therefore, dry production methods are critical in translating the magnetic activated carbon technology to full-scale. The use of physical methods to create a co-mingled product for mercury capture has been taught by U.S. Pat. No. 8,057,576 (“576 Patent”). The product is an admixture of an adsorptive material and an additive that either complexes with the mercury, oxidizes it, or both. The additive is not implanted on the adsorbent surface. This is highlighted by the fact that one embodiment of the patent teaches injecting the adsorbent and additive separately into the flue gas. The invention of the '576 Patent does not include a magnetic additive, and therefore the product cannot be magnetically recovered from fly ash.

### SUMMARY

By physically implanting magnetic additives on the adsorbent through dry production methods a cost-effective manner in which an adsorbent for mercury capture can be generated at a large scale.

Disclosed herein are processes to manufacture a magnetic adsorbent, a method using the magnetic adsorbent for the removal of contaminants from fluid streams, and the recovery of the magnetic adsorbent after use.

More specifically, a magnetic adsorbent with sufficient oxidizing power, affinity, and surface area for the capture of mercury from the flue gas of coal combustion devices is provided. This material may also be applied for the capture of other target contaminants such as arsenic and selenium. The magnetic adsorbent can then be recovered from the coal combustion flyash, and re-injected into the flue gas for additional mercury capture.

A method of manufacturing the magnetic adsorbent involves combining the selected adsorbent with a magnetic additive and in some cases an oxidizing additive. The precursor adsorbent may be an activated carbon, reactivated carbon, silica gel, zeolite, alumina clay, or other solid material with sufficient surface area for mercury capture. The magnetic additive is preferably one of the following: magnetite, hematite, goethite, or maghemite. The oxidizing additives may include, but are not limited to halides of alkali metals, alkaline earth metals, and ammonium (i.e., NH₄Br, KBr, LiBr, NaBr, NaCl, KCl, LiCl, KI, LiI, NaI), and semiconductors (TiO₂, ZnO, SnO₂, VO₂, and CdS).

A method for the manufacture of a magnetic adsorbent (Magnetic Adsorbent Creation Method), its application to remove contaminants from a fluid stream, and its recovery after use is provided.

A method to manufacture the magnetic adsorbent, involves combining the selected adsorbent with a magnetic additive and in some cases additional additives to improve the oxidation capacity. The additives may be implanted on the adsorbent using a variety of means, including but not limited to: mixing, milling, or grinding the adsorbent and the additives together until some fraction of the material is physically implanted on the surface of the activated carbon.

Furthermore, a method for removing a contaminant or contaminants from a fluid stream is provided (Contaminant Removal Method). The method includes contacting the fluid stream with the magnetic adsorbent whereby the contaminant is adsorbed on the magnetic adsorbent, and then removing the magnetic adsorbent having the contaminant adsorbed thereon from the fluid stream.

Also provided is a method to recycle the collected composite back into contact with the fluid stream for further contaminant removal (Composite Recycling Method).

In one embodiment, a magnetic adsorbent includes an adsorbent and iron oxide implanted onto a surface of the adsorbent, wherein a total surface area of the magnetic adsorbent is not substantially less than a total surface area of the adsorbent. Optionally, the adsorbent is activated carbon. In one configuration, an additive selected from the group consisting of a halogen, a photocatalyst, and a binder is added. In one alternative, the magnetic adsorbent does not include secondary deposits. Optionally, a ratio of the weight of the iron oxide to a total weight of the magnetic adsorbent is between 1% to 20%. In one configuration, a ratio of the weight of the iron oxide to a total weight of the magnetic adsorbent is between 5% to 15%. Alternatively, a ratio of the weight of the iron oxide to a total weight of the magnetic adsorbent is 10%. Optionally, the iron oxide is highly crystalline after implantation. In one configuration, a crystalline nature of the iron oxide is maintained after implantation.

In another embodiment, a magnetic adsorbent consists essentially of an adsorbent; and an iron oxide implanted onto the surface of the adsorbent, wherein a surface area of the magnetic adsorbent is not substantially less than the surface area of the adsorbent. In one configuration the adsorbent is activated carbon.

In one embodiment, a method of making a magnetic adsorbent includes combining an adsorbent and a magnetic material using mechanical mixing equipment. Optionally, the adsorbent is activated carbon and the magnetic material is iron oxide. In one alternative, the mechanical mixing equipment is selected from the group consisting of a ball mill, a jet mill, and a conical mill. In another alternative, the mechanical mixing equipment encourages friction and collision between particles. Optionally, the method includes implanting the magnetic material on the surface of the adsorbent. In another alternative, the combining includes grinding and is performed until the magnetic adsorbent will pass through a 325-mesh sieve.

In one embodiment, a method of treating an effluent stream includes treating the effluent stream by injecting magnetic adsorbent particles and using magnetic field to recover the magnetic adsorbent particles. Optionally, the magnetic adsorbent particles are re-injected into the effluent stream with additional magnetic adsorbent particles after recovery. Optionally, the magnetic adsorbent particles remove mercury from the effluent stream.

In another embodiment, high quality fly ash is recovered from a stream treated by a magnetic adsorbent. The method includes capturing the magnetic adsorbent from fly ash in the effluent stream using a magnetic field to generate two products: (1) high quality fly ash, and (2) recovered magnetic adsorbent.

In one embodiment, a system for removing mercury from an effluent system includes an activated carbon injection system, injecting an activated carbon product into an effluent. The system further includes a first electrostatic precipitator positioned after the activated carbon injection system, receiving the effluent. Optionally, the first electrostatic precipitator is positioned immediately following the activated carbon injection system, without any intervening treatments. In one alternative, the activated carbon product is magnetic. In another alternative, the activated carbon product includes a photocatalyst. Optionally, the first electrostatic precipitator activates the photocatalyst. Alternatively, a second electrostatic precipitator immediately precedes the activated carbon injection system. Optionally, the activated carbon product has iron oxide implanted on the surface and has a surface area that is not substantially less than the surface area without the iron oxide.

In another embodiment, an adsorbent includes an activated carbon portion and a magnetic portion joined with the activated carbon portion, wherein magnetic activity of the magnetic portion is not shielded by the activated carbon portion. Optionally, the magnetic portion is implanted on the surface of the activated carbon portion. Alternatively, a total surface area of the activated carbon portion without the magnetic portion is substantially at least the same as a total surface area of the adsorbent.

### BRIEF DESCRIPTION OF THE DRAWINGS

FIG. 1 shows an SEM image and EDS map of the titania and iron signals of the activated carbon adsorbent, demonstrating the absence of additives on the adsorbent surface;

FIG. 2 shows an SEM image and an EDS map of the iron signal of a magnetic adsorbent prepared by milling an activated carbon material with magnetite at a loading of 10% by weight, demonstrating the distribution of magnetite throughout the sample, on its surface;

FIG. 3 represents a spot EDS analysis on a particle isolated in FIG. 2, demonstrating the clear presence of iron on the adsorbent;

FIG. 4 represents an SEM image and an EDS map of the iron and titania signal of a magnetic adsorbent prepared through ball-milling an activated carbon adsorbent with TiO₂ and magnetite at 1% and 10% loading by weight, respectively. The image demonstrates the wide distribution of magnetite, as well as the presence of titania, on the adsorbent surface;

FIG. 5 represents a spot EDS analysis on a particle isolated in FIG. 4, demonstrating the clear presence of iron on the adsorbent;

FIG. 6 represents a spot EDS analysis on a particle isolated in FIG. 4, demonstrating the clear presence of titania on the adsorbent;

FIG. 7 represents an SEM image and an EDS map of the iron signal of a magnetic adsorbent prepared with magnetite, at a loading of 10% by weight, via mechanofusion. The figure demonstrates the distribution of magnetite throughout the sample, on its surface;

FIG. 8 represents a schematic of the bench scale apparatus used to collect the fixed bed data presented herein;

FIG. 9 represents the mercury removal curve during a fixed bed evaluation with various magnetic adsorbent materials, demonstrating the benefit of additives for mercury removal;

FIG. 10 represents the mercury removal curve during actual flue gas conditions with the base activated carbon and the produced magnetic adsorbent, demonstrating the benefit for mercury removal;

FIG. 11a and 11b show embodiments of an activate carbon injection system up stream of an electrostatic precipitator (ESP);

FIG. 12 shows Mercury removal curve for activated carbon injection in a 5 MW slip stream flue gas for a PAC readily available for commercial purchase in the industry (Industry Carbon), a MPAC coated with 10% Fe₃O₄ (MPAC), with 10% Fe₃O₄ and 1% TiO₂ (MPAC-TiO₂), and another with 10% Fe₃O₄ and 2.5% NaBr (MPAC-Na—Br) by weight.

### DETAILED DESCRIPTION OF THE DRAWINGS

In one embodiment of a Magnetic Adsorbent Creation Method, magnetic adsorbent composites are prepared, whereby a magnetic material is physically implanted onto the exposed surface of an adsorbent. The implantation may be achieved by simultaneously combining the adsorbent and iron oxide together and using mechanical mixing equipment such as a ball mill, jet mill, conical mill, etc. This mixing environment encourages friction and collision between the particles to promote implantation. Forces for implantation may include Van der Waals Forces, capillary forces, electrical forces and electrostatic coulomb forces. These forces may be promoted during the mixing process.

Surface implantation is an important feature of the magnetic adsorbent created, in contrast to some prior art adsorbents where the magnetic material is implanted within the adsorbent; implantation on the surface does not shield or block the magnetic forces from acting on the magnetic material. This feature provides for the recapture and recycling of magnetic adsorbent since magnetic forces may be applied to recapture it after treatment. This greatly improves the cost effectiveness of the methods and materials described herein. In various places herein the implantation of magnetic materials is discussed. Significant variation of the amount and type of magnetic material implanted is contemplated and may be related to the implantation techniques used and described herein.

The adsorbent material for the creation of a magnetic adsorbent will have an appreciable surface area and developed porosity. It can be: activated carbon, reactivated carbon, zeolite, alumina clays, silica gels, etc. For many applications the adsorbent is activated carbon. The term “activated carbon” as used herein is meant to reference powdered or granular carbon used for purification by adsorption. In many configurations the activated carbon used has a surface area between 200 and 1,000 m²/g, more preferably between 300 and 700 m²/g, and most preferably between 400 and 600 m²/g. In some alternatives, powder activated carbon (PAC) is used. For this application, the term “Powdered Activated Carbon” refers to an activated carbon, 90% of which passes through a 352-mesh sieve (45 nm) (i.e., at least 90% passes through a 352 mesh). Also, the following abbreviations may be used herein: Activated Carbon: AC; Powdered Activated Carbon: PAC; and Magnetic Powdered Activated Carbon: MPAC.

The magnetic material may be at least one of the following: magnetite (Fe3O4), maghemite (γ-Fe₂O₃), hematite (α-Fe₂O₃) and goethite (FeO(OH)); and in many embodiments magnetite. The amount of magnetic material in the composite is preferably between at least 1% and less than 20% by weight based on the total weight of the final composite; more preferably between 5% and 15% by weight based on the total weight of the final composite; most preferably 5% by weight based on the total weight of the final composite.

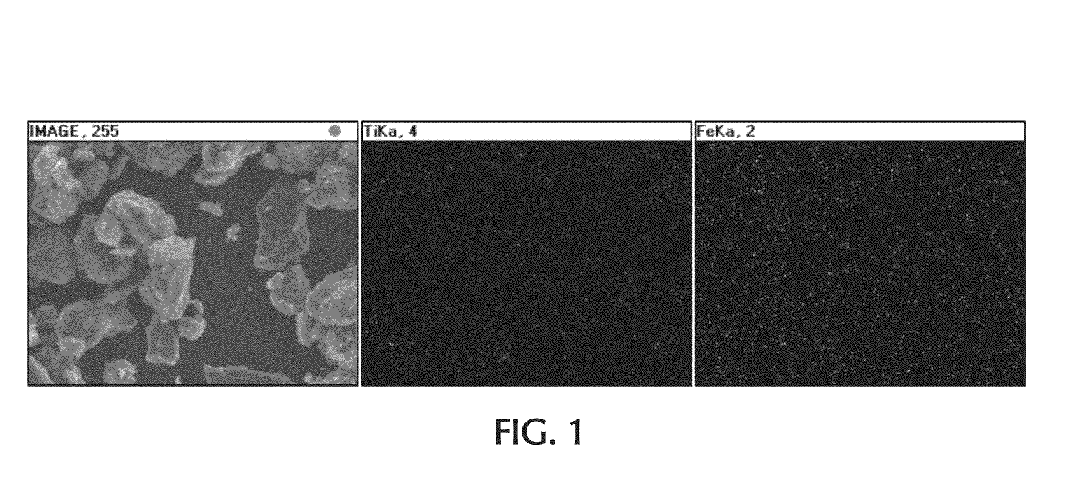

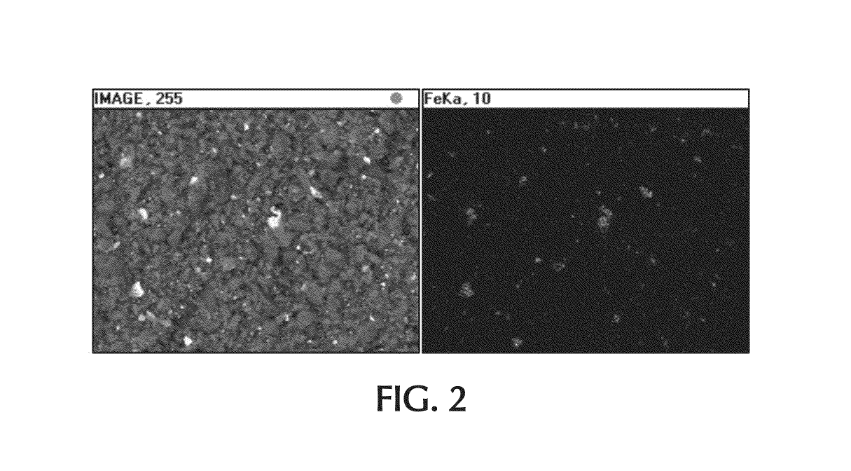

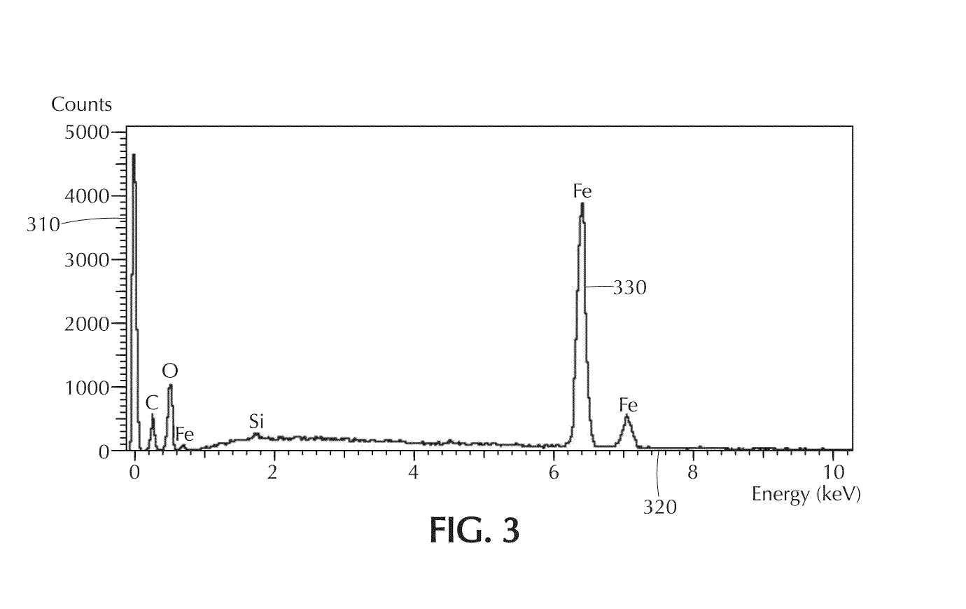

FIGS. 1-3 show the results of a composite made as described above. FIG. 1 shows an SEM image and EDS map of the titania and iron signals of the activated carbon adsorbent at 500 times magnification, demonstrating the absence of additives on the adsorbent surface according to one embodiment. In FIG. 1 an SEM image and an EDS (Energy-dispersive X-ray spectroscopy) map show the iron signals appearing on the activated carbon. FIG. 2 shows a sample created according to the milling with activated carbon described above. FIG. 2 shows an SEM image and an EDS map of the iron signal of a magnetic adsorbent at 500 times magnification prepared by milling an activated carbon material with magnetite at a loading of 10% by weight, demonstrating the distribution of magnetite throughout the sample, on its surface. In FIG. 3 a graph showing the occurrence of primarily Fe 330 on the activated carbon is shown as compared to other contaminates. FIG. 3 represents a spot EDS analysis on a particle isolated on Fe-particle in ball milled sample (FeOx), demonstrating the clear presence of iron on the adsorbent. The graph shows the counts 310 vs. energy (keV) 320. FIG. 1 shows an SEM image and EDS map of the titania and iron signals of the activated carbon adsorbent at 500 times magnification, demonstrating the absence of additives on the adsorbent surface according to one embodiment;

Additionally, other additives, such as oxidizers, photocatalysts, and binders, may be applied. Oxidizing additives may be selected from halides of alkali metals, alkaline earth metals, and ammonium (i.e., NH₄Br, KBr, LiBr, NaBr, NaCl, KCl, LiCl, KI, LiI, NaI) and photocatalysts (i.e., TiO₂, ZnO, VO₂, SnO₂, and CdS). Some oxidizing additives and photocatalyts may also act as a binder, encouraging the magnetic additives to adhere to the adsorbent surface. Other separate binders may also be applied (i.e., Binders). In many embodiments described herein, the adsorbent is activated carbon, the magnetic material is magnetite, and the oxidizing and/or binding additives are NaBr and/or TiO₂. The amount of additional additive material in the composite is preferably between at least 0.1% and less than 10% by weight based on the total weight of the final composite; more preferably between 0.5% and 5% by weight based on the total weight of the final composite.

Additional features of embodiments of magnetic adsorbent created include unique iron oxide concentration, the crystalline nature of the iron oxide included, the absence of secondary deposits or byproducts on the surface, the impact on the physical characteristics of the magnetic adsorbent, and the additives that may be added. In some embodiments, the iron oxide concentration of the magnetic adsorbent produced is between 1% and 20% by weight, more preferably between 5% and 15% by weight, most preferably 10% by weight. By using magnetic additives such as (maghemite (γ-Fe₂O₃), hematite (α-Fe₂O₃) and magnetite (Fe₃O₄)) that are already crystalline in nature, the Magnetic Adsorbent Creation Method produces an adsorbent that maintains the crystalline structure of the magnetic material. This crystallinity is likely greater than that of materials produced via wet chemistry methods. Further, since heat treatments are not necessary in the Magnetic Adsorbent Creation Method, the crystalline nature is not degraded.

The occurrence of secondary deposits is also reduced or eliminated by the Magnetic Adsorbent Creation Method. In contrast, wet chemistry methodologies may include reactants that leave byproducts and interact with the adsorbent or iron oxide. The Magnetic Adsorbent Creation Method further does not erode the pore volume or pore size of the magnetic adsorbent and may result in a slight measurable increase in total surface area caused by interstitial spaces created by the adhered particles on the surface of the activated carbon adding to the available surface area. In many wet chemistry methodologies the deposition of iron oxides may degrade the surface area, pore size, and pore volume. The magnetic adsorbent can be treated with a halogen, a photocatalyst, or a binder to further enhance the mercury oxidation and therefore adsorption and removal from the contaminated stream.

By adding a known magnetic species, the magnetic strength is controlled and deposited on the surface of the adsorbent. Surface-deposition of the magnetic material allows magnetic forces for recovery to be maximized. Further, the speciation and crystallinity of the magnetic material is not altered by production, thereby protecting its magnetic properties. This is in contrast to those methods that deposit the magnetic material within the sorbent, where the sorbent material itself can mask the magnetic forces and hinder recovery. Additionally, those methods that teach magnetic doping of a sorbent precursor followed by activation will likely face difficulties controlling the speciation and crystallinity, and therefore the magnetic properties, of the magnetic compounds.

Once production is complete, the material can be applied for contaminant removal in a fluid stream. While the said material has the potential to be effective for various contaminants in a myriad of fluid streams, it is known to be effective for the contaminant mercury and the fluid stream of flue gas. In this representation, the material is removed from the flue gas by typical particle collection devices in operation, such as electrostatic precipitators, fabric filters, cyclones, and even scrubbers. It will be appreciated by those skilled in the art that although embodiments are described in connection with the removal of mercury from flue gas, embodiments not limited to the removal of mercury from flue gas and may be used to remove other heavy metals including, but not limited to, arsenic, selenium, and boron.

After the composite is separated from the fluid stream and collected, it can be recovered and reused. The recovery utilizes the magnetic properties of the material. Using the above scenario as an example, the magnetic material is collected in an electrostatic precipitator with other flue gas particles (fly ash). A magnetic recovery system is applied after the electrostatic precipitator collection to separate the magnetic material from the fly ash. The magnetic material is then stored for reuse. Additionally, before reuse, the material may be regenerated using chemical or thermal techniques. The material may then be reapplied for further contaminant removal from the fluid stream. Utilizing this technique results in significant cost savings for the user and reduces the quantity of waste materials.

In one embodiment the composite is treated with a halogen known for oxidizing Hg. In this regard, the halogenated composite may be formed by (i) mechanically mixing a halogen compound, a magnetic material and adsorbent; (ii) exposing the composite of adsorbent and magnetic material to a halogen gas; or (iii) reacting the magnetic material and a halogen, then co-milling the resultant with adsorbent.

In another embodiment a photocatalyst, for example, titanium dioxide (TiO₂), is included in the magnetic adsorbent. Hydroxyl radicals can be generated on the surface of TiO₂ in an excited state; these powerful oxidants enhance mercury capture by oxidizing elemental Hg to form, for example, HgO. The oxidized mercury (e.g., HgO) can then serve as additional sorption sites for elemental Hg, increasing mercury capture as a whole. Furthermore, as the adsorbent is re-injected for mercury capture, the gradual buildup of HgO on the sorbent may improve mercury uptake over the injection cycles. In those scenarios where electrostatic precipitators (ESP) are used for particulate capture, the energy required to excite TiO₂'s electrons to generate hydroxyl radical formation is provided by the ESP itself. For bag house installations, UV lamps generating wavelengths less than about 365 nm would be required to provide the required energy for TiO₂ excitation. As would be recognized by one skilled in the art, UV radiation includes invisible radiation wavelengths from about 4 nanometers, on the border of the x-ray region, to about 380 nanometers, just beyond the violet in the visible spectrum.

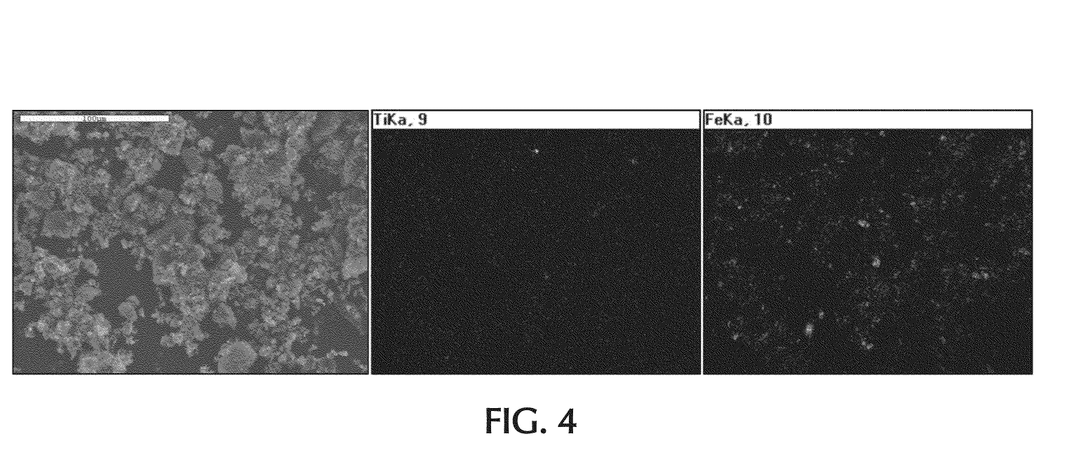

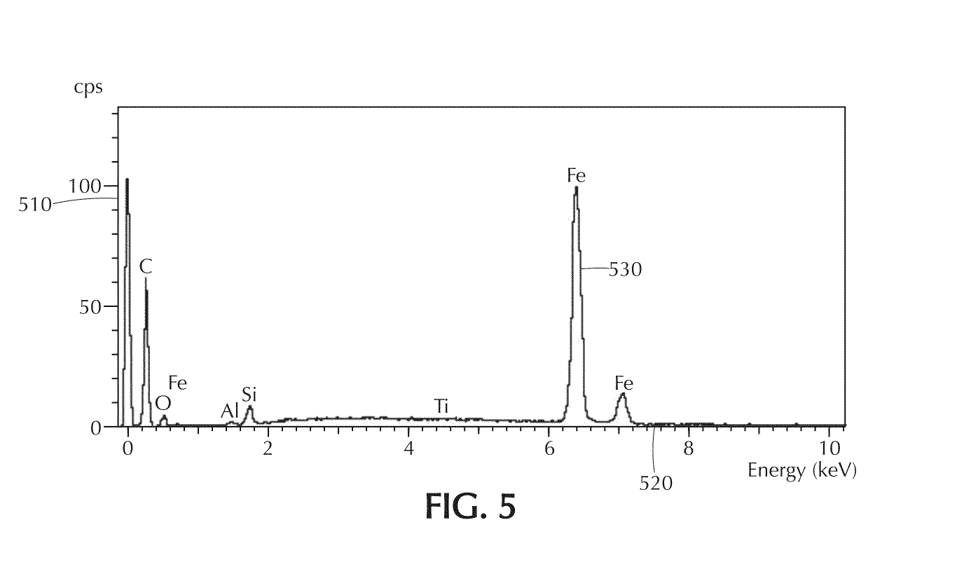

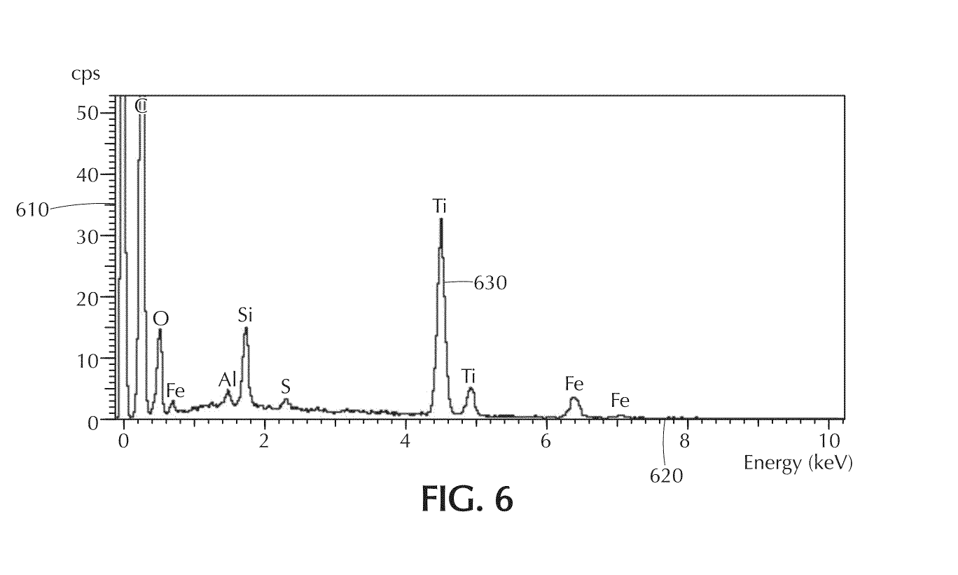

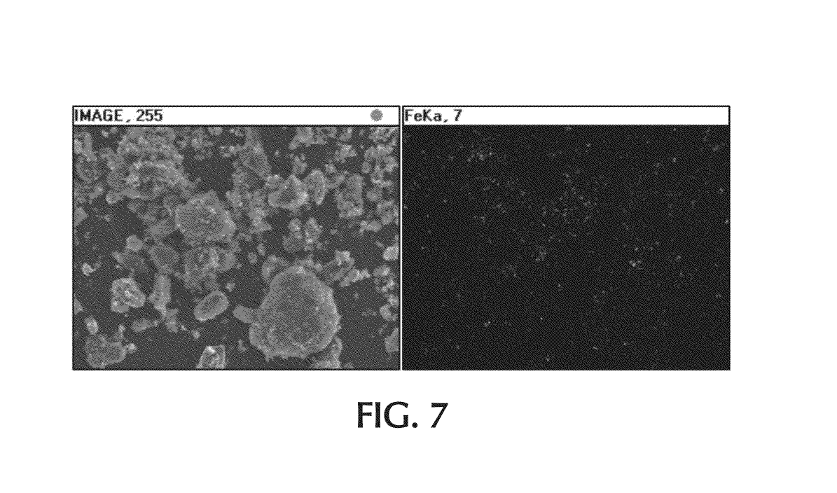

FIGS. 4-6 show the results from preparing a ball milled sample as described above with TiO₂/FeOₓ. FIG. 4 represents an SEM (Scanning Electron Microscope) image and an EDS map of the iron and titania signal of a magnetic adsorbent (at 500 times magnification) prepared through ball-milling an activated carbon adsorbent with TiO₂ and magnetite at 1% and 10% loading by weight, respectively, demonstrating the wide distribution of magnetite, as well as the presence of titana, on the adsorbent surface. FIG. 5 represents a spot EDS analysis on a particle isolated on Fe-particle in ball milled sample (TiO₂/FeOₓ), demonstrating the clear presence of iron on the adsorbent. FIG. 5 demonstrates the existence of iron with peak 530. The graph shows the counts 510 vs. energy (keV) 520. FIG. 6 represents a spot EDS analysis on a particle isolated on Ti-particle in ball milled sample (TiO₂/FeOₓ), demonstrating the clear presence of titania on the adsorbent. FIG. 6 demonstrates the existence of Ti with peak 630. The graph shows the counts 610 vs. energy (keV) 620. FIG. 7 represents an SEM image and an EDS map of the iron signal of a magnetic adsorbent (at 500 times magnification) prepared with magnetite, at a loading of 10% by weight, via mechanofusion; demonstrating the distribution of magnetite throughout the sample, on its surface.

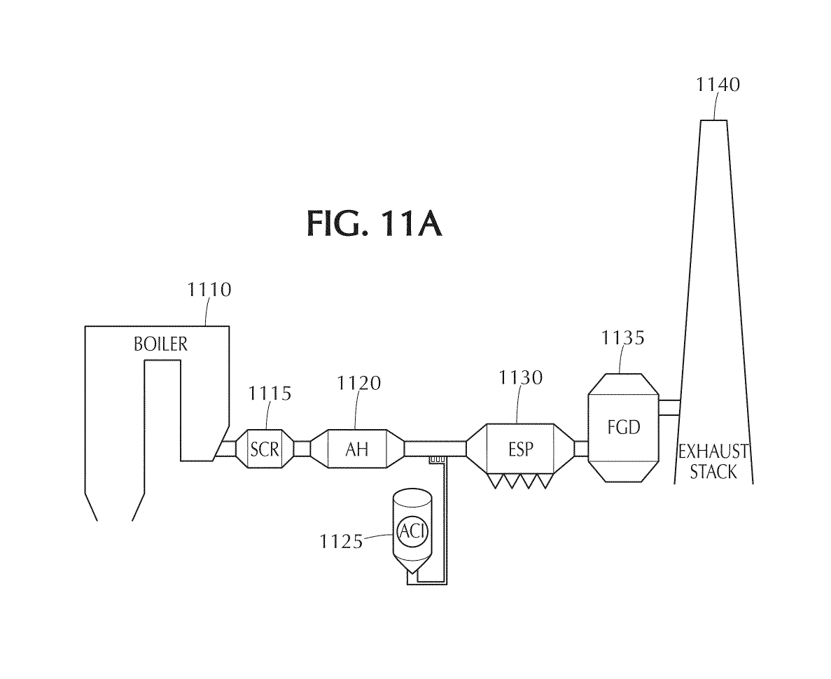

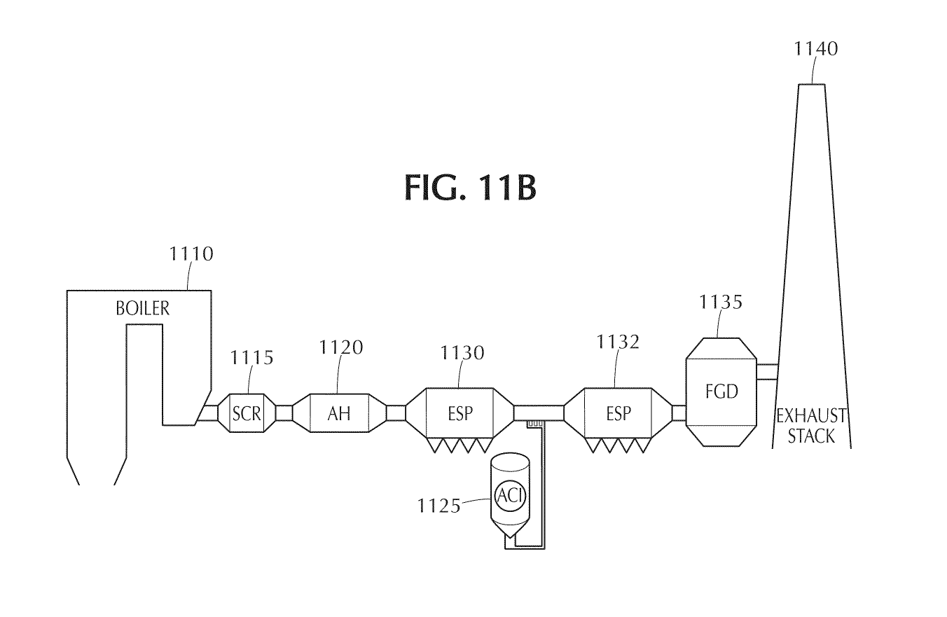

The magnetic adsorbent will have a specific fraction of magnetized particles depending on the manufacturing technique. In some embodiments, this fraction is recoverable from fly ash or other non-magnetic particles from fluid streams (such as air and water). The magnetic recovery is achieved by passing a mixed particle stream through a magnetic recovery device. One example is using a design similar to an electrostatic precipitator (ESP) with electromagnets to collect the magnetic adsorbent while allowing the other particles to pass through the collection device. The recovered magnetic adsorbent can then be regenerated or reused, depending on the application. In flue gas treatment for mercury, magnetic adsorbent is separated from the other particles (fly ash) in the flue gas airflow. The recovered, used magnetic adsorbent would be mingled with fresh magnetic adsorbent, and then injected again for in-flight mercury capture. This has the added benefit of improving the quality of the flyash for potential salability. FIG. 11a and 11b show two embodiments of an activated carbon injection system positioned before and between an ESP. Boiler 1110 feeds to a selective catalytic reduction system 1115. Then the effluent flows to an air heater 1120. At this point, activated carbon is injected from ACI 1125. The activated carbon then passes through the ESP 1130 which produces an electrostatic discharge, which, in some embodiments, can excite the properties of the activated carbon to result in enhanced mercury removal. Finally, the flue gas passes through the flue gas desulfurization 1135 and out of exhaust stack 1140. In FIG. 11b a first ESP 1130 precedes the injection of activated carbon and a second ESP 1132 follows. The injection may also occur before both ESPs. Other instances would exclude the use of a selective catalytic reduction system 1115 or a flue gas desulfurization 1135. The activated carbon in many of these cases, as described above, includes a photocatalyst. The advantage of this system is that similar results may be achieved as compared to an activated carbon system with a fabric filter, without the same pressure drop as would be experienced with a fabric filter. In some cases an ACI system and an added ESP system may be used to retrofit existing plants. As mentioned above, this system may provide synergy with the magnetic adsorbent for mercury removal but be less costly than other well established retrofits known by those skilled in the art, such as a fabric filter installation for ACI, and may be easily integrated into existing systems. In some configurations, the positioning of the ESP in a typical system may enhance the activity of the activated carbon as compared to systems injecting activated carbon at an earlier point in the system. Typically, ESP systems are located near the end of an effluent cleaning system as shown in FIGS. 11a and 11b. Therefore, activated carbon may be injected immediately before the ESP and may have higher effectiveness since the effluent will have cooled significantly by that point in the system. Also, fewer other constituents may exist in the effluent immediately before the ESP, therefore allowing the activated carbon to work primarily to remove Mercury. The specific configuration of the system will determined the exact operating parameters and removal capabilities. In some embodiments halogens may be substituted for the photocatalyst.

### Example 1

### Preparation of Activated Carbon/Iron Composite

A magnetic activated carbon sample with a 10% by weight concentration of magnetite (Fe₃O₄) was prepared by simultaneously grinding 9 g of activated carbon with 1 g of magnetite in a ball mill. Grinding continued until 90% of the final product would pass through a 325-mesh sieve. A virgin product was also prepared using the same activated carbon, but with no additive, milled to the same specification.

### Hg Removal

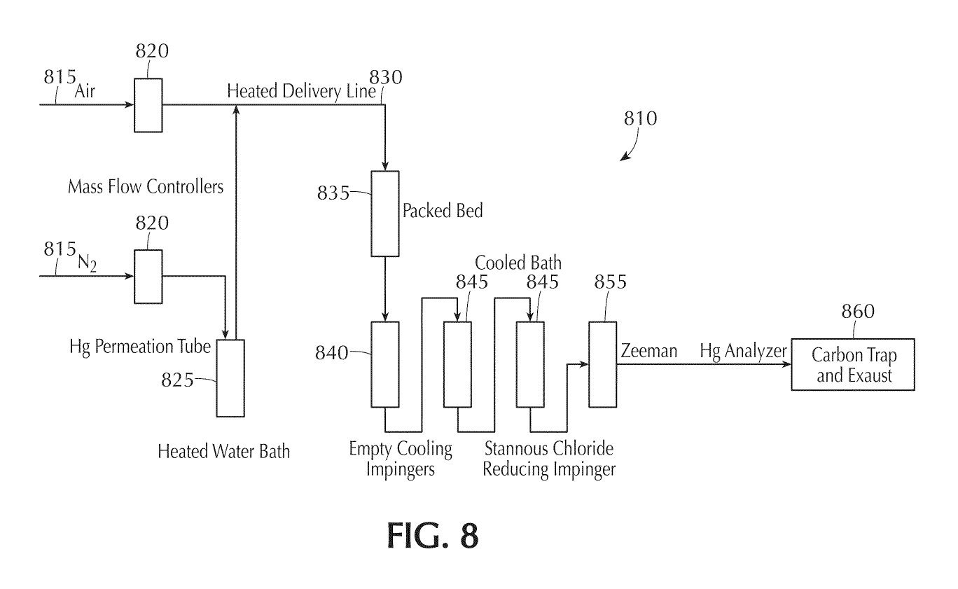

FIG. 8 presents the bench-scale test stand that was used to quantify the adsorption capacity of the inventive MPAC.

Air 815 and High-grade nitrogen gas 815 were passed through mass flow controllers 820, to control the flow of air representing effluent into the system. The nitrogen gas 815 from reservoir was passed through an elemental mercury permeation tube 825 to create a mercury vapor laden air with 10 ug/m³ of Hg. The mercury vapor was then transported through a heating tube 830 to the fixed-bed reaction column. The temperature of the Hg gas was monitored and maintained at 150° C. upstream of the MPAC 835. The sorbent was evenly dispersed within a matrix of silica sand, and supported on a quartz frit. The temperature of the sorbent bed was monitored and maintained at 110° C. using heating tape. Effluent gas from the sorbent bed was cooled using a series of impingers 840, 845 in a water bath prior to monitoring elemental Hg by an inline RA-915 Zeeman Mercury Spectrometer (Ohio Lumex) 855. Effluent concentrations of mercury from the stand were recorded for comparison of composite PAC samples. A carbon trap and exhaust system 860 collected remaining waste from the system.

The Hg adsorption capacities of the composite and the virgin counterpart were quantified using the test stand shown in FIG. 8. Table 1 summarizes the test results. As shown, the addition of iron oxide produced a sorbent with greater Hg removal capacity. Table 2 shows the characteristics of the virgin AC and the composite product.

TABLE 1
Hg Removal Results for the Virgin AC and MPAC Products

| | Loading (mg Hg/g sorbent) | | |
|---|---|---|---|
| Sorbent | t = 30 s | t = 1 min | t = 5 min |
| Virgin AC | 1.7 | 3.4 | 11.2 |
| MPAC, 5% Fe₃O₄ | 7.8 | 16.5 | 39.2 |

TABLE 2
Characteristics of Virgin AC and MPAC Products

| | BET | Pore size | Pore Vol. | BJH P. Vol. |
|---|---|---|---|---|
| Sample | m²/g | Å | cc/g | cc/g |
| Base AC | 382 | 10.6 | 0.20 | 0.05 |
| MPAC, 5% Fe₃O₄ | 370 | 30.6 | 0.28 | 0.13 |

It is clear from the data in Table 1 that the iron oxide coating improved the ability of the sorbent to trap Hg from the air stream. This is likely attributable to the iron oxidizing the elemental Hg to Hg(II), which is more amenable for adsorption by activated carbon.

### Example 2

### Preparation of Activated Carbon/Iron Composite

A magnetic activated carbon sample with a 10% by weight concentration of magnetite (Fe₃O₄) was prepared by simultaneously milling 18 lbs. of activated carbon with 2 lbs. of magnetite in a ball mill. Grinding continued until 95% of the final product would pass through a 325-mesh sieve. Two additional sorbents were made by adding additional oxidants. The first was prepared by simultaneously milling 18 lbs. of activated carbon with 2 lbs. of magnetite and 0.2 lb. of TiO₂ in a ball mill to the same size specification as the first. The second was prepared by simultaneously milling 18 lbs, of activated carbon with 2 lbs. of magnetite and 0.5 lb. of NaBr in a ball mill to the same size specification as the first. A fourth carbon was procured from a commercial activated carbon supplier designed for the mercury removal from flue gas application.

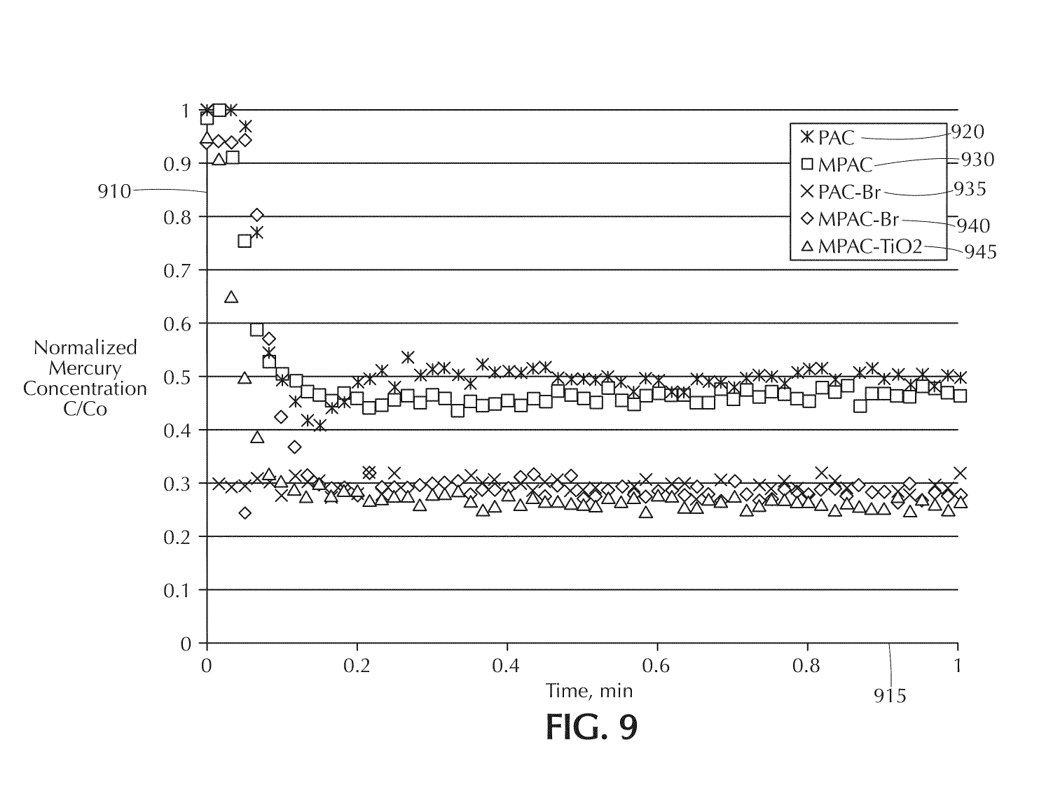

Following from the above examples, FIG. 9 represents the mercury removal curve during a fixed bed evaluation with various magnetic adsorbent materials, demonstrating the benefit of additives for mercury removal. The y-axis 910 shows the normalized mercury concentration in C/Co. The x-axis 920 represents time in minutes. The results for various additives are shown including PAC 920, MPAC 930, PAC-Br 935, MPAC-Br 940, and MPAC-TiO₂ 945 in accordance with the various embodiments described herein.

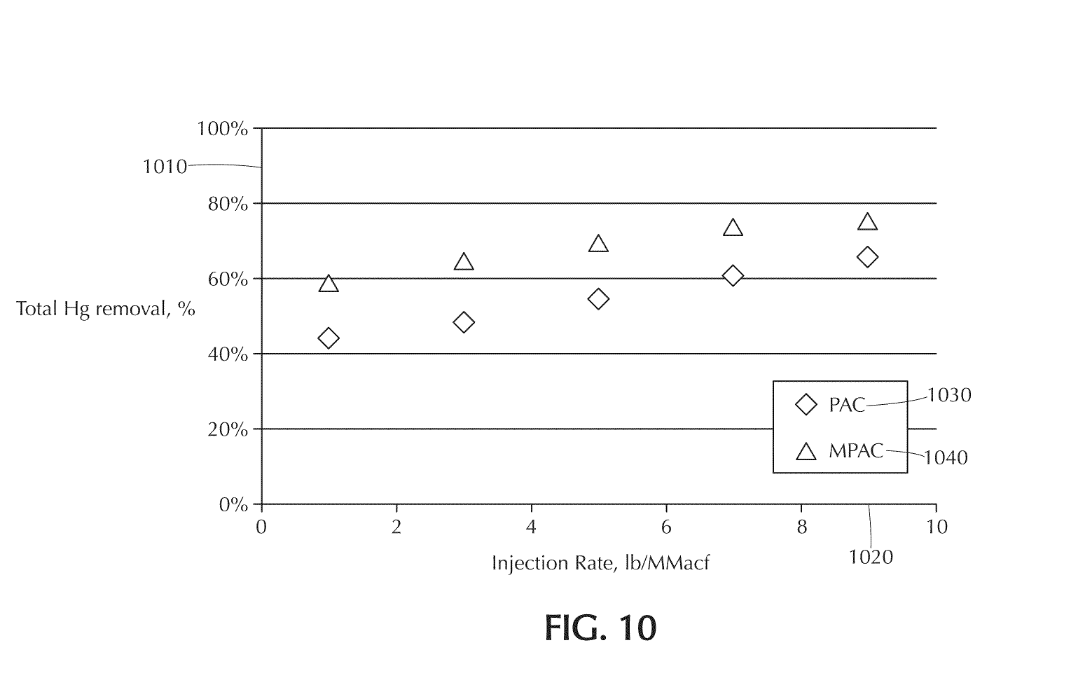

FIG. 10 represents the mercury removal curve during actual flue gas conditions with the base activated carbon (injection in a 5 MW slip stream flue gas for a Base AC (PAC) 1030 and a MPAC 1040 coated with 5% Fe3O4 by weight) and the produced magnetic adsorbent, demonstrating the benefit for mercury removal. The y-axis 1010 shows the total percentage of mercury removal and the x-axis shows the injection rate in lb/MMacf.

### Mercury Removal

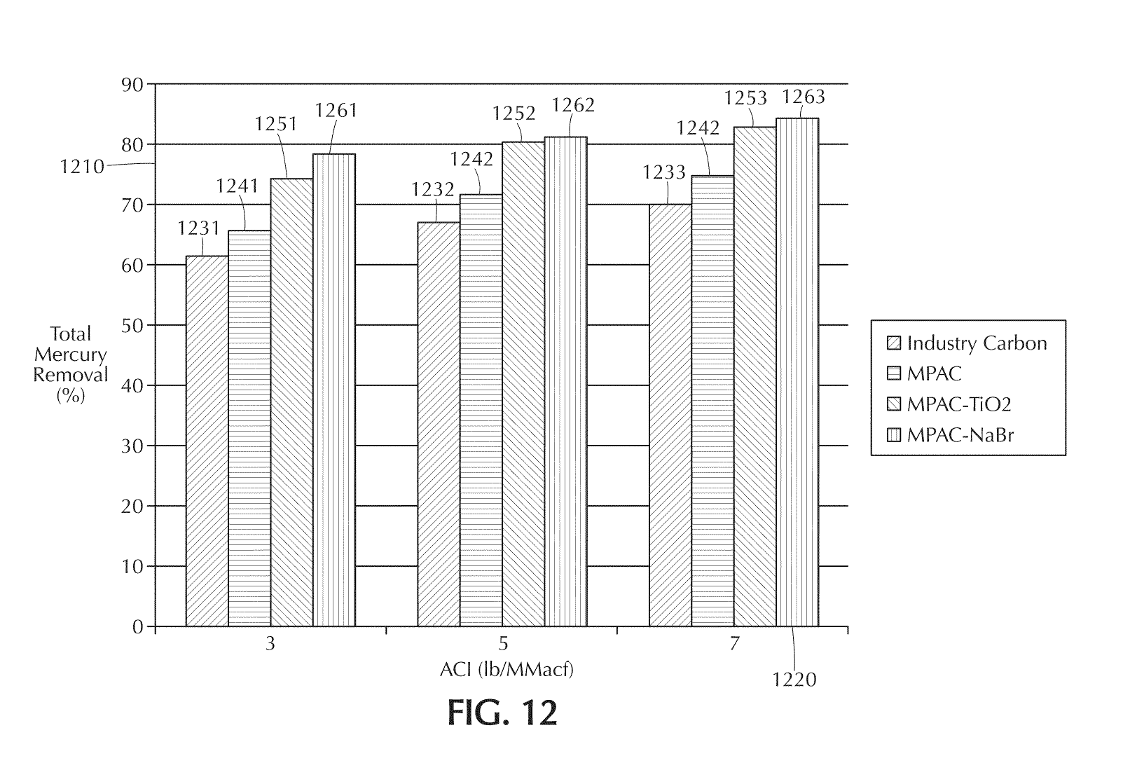

The four products were tested at the Mercury Research Center (MRC). The MRC removes a constant flow of approximately 20,500 acfm of flue gas (representative of a 5 MW boiler) from the Southern Company Plant Christ Boiler (78 MW). The boiler runs on low-sulfur bituminous coal blend from varying sources. While typical SO3 concentrations of previous fuel blends resulted in less than 1 ppm of SO3, the current coal blend lead to SO3 concentrations between 2-3 ppm downstream of the air heater (AH). The products were pneumatically injected at 3, 5, and 7 lb/MMacf injection rates upstream of the electrostatic precipitator (ESP). Particulate removal was achieved with the ESP. Mercury concentrations were monitored at the MRC inlet and just downstream of the ESP and the observed concentrations were adjusted to 3% oxygen concentration for the purpose of standardization for comparison. Total mercury removal was calculated as the inlet mercury concentration (in ug/m3 at STP and 3% O2) minus the outlet mercury concentration (in ug/m³ at STP and 3% O₂) divided by the inlet and is illustrated in FIG. 12. Compared to the commercially available activated carbon, the MPAC carbons 1241, 1242, 1243, 1251, 1252, 1253, 1261, 1262, 1263, show significant advantage in higher mercury removal percentages. In the figure showing the activated carbon injection in a 5 MW slip stream flue gas the bars shown are as follows: a PAC 1231, 1232, 1233, readily available for commercial purchase in the industry (Industry Carbon), a MPAC coated with 10% Fe₃O₄ (MPAC) 1241, 1242, 1243, with 10% Fe₃O₄ and 1% TiO₂ (MPAC-TiO₂) 1251, 152, 1253, and another with 10% Fe₃O₄ and 2.5% NaBr (MPAC-Na—Br) 1261, 1262, 1263 by weight.

The previous detailed description is of a small number of embodiments for implementing the compounds and methods related to magnetic adsorbents, such as magnetic activated carbon, and are not intended to be limiting in scope. The following claims set forth a number of the embodiments of the compounds and methods related to magnetic adsorbents, such as magnetic activated carbon, disclosed with greater particularity.

What is claimed:

1. A magnetic adsorbent, comprising: an adsorbent; and iron oxide implanted onto a surface of the adsorbent, wherein a total surface area of the magnetic adsorbent is not substantially less than a total surface area of the adsorbent.

2. The magnetic adsorbent of claim 1 wherein the adsorbent is activated carbon.

3. The magnetic adsorbent of claim 1, further comprising an additive selected from the group consisting of a halogen, a photocatalyst, and a binder.

4. The magnetic adsorbent of claim 1 wherein the magnetic adsorbent does not include secondary deposits.

5. The magnetic adsorbent of claim 1 wherein a ratio of a weight of the iron oxide to a total weight of the magnetic adsorbent is between 1% to 20%.

6. The magnetic adsorbent of claim 1 wherein a ratio of a weight of the iron oxide to a total weight of the magnetic adsorbent is between 5% to 15%.

7. The magnetic adsorbent of claim 1 wherein a ratio of a weight of the iron oxide to a total weight of the magnetic adsorbent is 10%.

8. The magnetic adsorbent of claim 1 wherein the iron oxide is highly crystalline after implantation.

9. The magnetic adsorbent of claim 1 wherein a crystalline nature of the iron oxide is maintained after implantation.

10. A magnetic adsorbent, consisting essentially of an adsorbent; and an iron oxide implanted onto a surface of the adsorbent, wherein a total surface area of the magnetic adsorbent is not substantially less than a total surface area of the adsorbent.

11. The magnetic adsorbent of claim 10 wherein the adsorbent is activated carbon.

12. A method of making a magnetic adsorbent, comprising:
combining an adsorbent and a magnetic material using mechanical mixing equipment.

13. The method of claim 12 wherein the adsorbent is activated carbon and the magnetic material is iron oxide.

14. The method of claim 12 wherein the mechanical mixing equipment is selected from the group consisting of a ball mill, a jet mill, a classifier milling system or the like.

15. The method of claim 12 wherein the mechanical mixing equipment encourages friction and collision between particles.

16. The method of claim 12, further comprising implanting the magnetic material on the surface of the adsorbent.

17. The method of claim 12 wherein the combining includes grinding and is performed until the magnetic adsorbent will pass through a 325-mesh sieve.

18. A method of treating an effluent stream, comprising: treating the effluent stream by injecting magnetic adsorbent particles; using a magnetic field to recover the magnetic adsorbent particles.

19. The method of claim 18 wherein the magnetic adsorbent particles are re-injected into the effluent stream with additional magnetic adsorbent particles after recovery.

20. The method of claim 18 wherein the adsorbent particles have iron oxide implanted on the surface.

21. The method of claim 18 wherein the magnetic adsorbent particles remove mercury from the effluent stream.

22. A method of reclaiming high quality fly ash from effluent treated with powdered activated carbon, comprising: injecting magnetic absorbent to an effluent stream to remove contaminates from the effluent stream; capturing the magnetic absorbent using magnets; reclaiming fly ash from the effluent stream, the fly ash not containing the magnetic absorbent.

23. The method of claim 22 wherein the magnetic absorbent is created via grinding activated carbon and iron oxide together.

24. A system for removing mercury from an effluent system, the system comprising:
an activated carbon injection system, injecting an activated carbon product into an effluent;
a first electrostatic precipitator positioned after the activated carbon injection system, receiving the effluent.

25. The system of claim 24, wherein the first electrostatic precipitator is positioned immediately following the activated carbon injection system, without any intervening treatments.

26. The system of claim 24, wherein the activated carbon product is magnetic.

27. The system of claim 26, wherein the activated carbon product includes a photocatalyst.

28. The system of claim 27, wherein the first electrostatic precipitator activates the photocatalyst.

29. The system of claim 22, wherein a second electrostatic precipitator immediately precedes the activated carbon injection system.

30. The system of claim 26, wherein the activated carbon product has iron oxide implanted on a surface and has a total surface area that is not substantially less than a total surface area without the iron oxide.

31. The system of claim 25, wherein the activated carbon injection system is located subsequent to a selective catalytic reduction system and an air heater.

32. An adsorbent, comprising;
an activated carbon portion;
a magnetic portion joined with the activated carbon portion, wherein magnetic activity of the magnetic portion is not shielded by the activated carbon portion.

33. The adsorbent of claim 32, wherein the magnetic portion is implanted on the surface of the activated carbon portion.

34. The adsorbent of claim 32 wherein a total surface area of the activated carbon portion without the magnetic portion is substantially at least the same as a total surface area of the adsorbent.
